(19) United States
(12) Patent Application Publication
(10) Pub. No.: US 2005/0210438 A1
(43) Pub. Date: Sep. 22, 2005

(54) Modification of an image of a pattern during an imaging process

(75) Inventors: Leonardus Henricus Marie Verstappen, Weert (NL); Jozef Maria Finders, Veldhoven (NL); Andre Bernardus Jeunink, Bergeyk (NL); Wim Tjibbo Tel, Helmond (NL); Alexander Hendrikus Martinus Van Der Hoff, Valkenswaard (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 10/886,055

(22) Filed: Jul. 8, 2004

(30) Foreign Application Priority Data
Jul. 11, 2003 (EP) 03077204.0

(51) Int. Cl. G06F 17/50

(52) U.S. Cl. 716/21

(57) ABSTRACT

A method is provided for modifying an image of a pattern during a lithographic imaging process, where the pattern is arranged on a mask for imaging by a projection system on a surface, and the image is an image formed from the pattern by the projection system. In this method the imaging quality of the projection system is described by selected imaging quality parameters, and the image is adjustable by image adjustment parameters of the projection system. The method comprises the steps of determining an ideal image of the pattern, determining a simulated distorted image of the pattern based on the selected imaging quality parameters; determining a deviation between the simulated distorted image and the ideal image, and adapting the image adjustment parameters during the imaging process to minimize the deviation between the simulated distorted image and the ideal image on the basis of the selected imaging quality parameters.

This application claims priority from European Patent Application No. 03077204.0, filed Jul. 11, 2003, herein incorporated by reference in its entirety.

### FIELD OF THE INVENTION

The present invention relates to a method for modifying an image of a pattern during an imaging process, as well as to apparatus for modifying an image of a pattern during an imaging process, and to a lithographic projection apparatus using such a method.

### BACKGROUND OF THE INVENTION

The present invention finds application in the field of lithographic projection apparatus that encompass a radiation system for supplying a projection beam of radiation, a support structure for supporting a patterning device, which serves to pattern the projection beam according to a desired pattern, a substrate table for holding a substrate; and, a projection system for projecting the patterned beam onto a target portion of the substrate.

The term “patterning device” as employed here should be broadly interpreted as referring to devices that can be used to endow an incoming radiation beam with a patterned cross-section, corresponding to a pattern that is to be created in a target portion of the substrate; the term “light valve” can also be used in this context. Generally, the said pattern will correspond to a particular functional layer in a device being created in the target portion, such as an integrated circuit or other device (see below). Examples of such patterning devices include:

A mask. The concept of a mask is well known in lithography, and it includes mask types such as binary, alternating phase-shift, and attenuated phase-shift, as well as various hybrid mask types. Placement of such a mask in the radiation beam causes selective transmission (in the case of a transmission mask) or reflection (in the case of a reflective mask) of the radiation impinging on the mask, according to the pattern on the mask. In the case of a mask, the support structure will generally be a mask table, which ensures that the mask can be held at a desired position in the incoming radiation beam, and that it can be moved relative to the beam if so desired;

A programmable mirror array. One example of such a device is a matrix-addressable surface having a visco-elastic control layer and a reflective surface. The basic principle behind such an apparatus is that (for example) addressed areas of the reflective surface reflect incident light as diffracted light, whereas unaddressed areas reflect incident light as non-diffracted light. Using an appropriate filter, the said non-diffracted light can be filtered out of the reflected beam, leaving only the diffracted light behind; in this manner, the beam becomes patterned according to the addressing pattern of the matrix-addressable surface. An alternative embodiment of a programmable mirror array employs a matrix arrangement of tiny mirrors, each of which can be individually tilted about an axis by applying a suitable localized electric field, or by employing piezoelectric actuators. Once again, the mirrors are matrix-addressable, such that addressed mirrors will reflect an incoming radiation beam in a different direction to unaddressed mirrors; in this manner, the reflected beam is patterned according to the addressing pattern of the matrix-addressable mirrors. The required matrix addressing can be performed using suitable electronic circuitry. In both of the situations described here above, the patterning device can comprise one or more programmable mirror arrays. More information on mirror arrays as here referred to can be gleaned, for example, from U.S. Pat. No. 5,296,891 and U.S. Pat. No. 5,523,193, and PCT patent applications WO 98/38597 and WO 98/33096, which are incorporated herein by reference. In the case of a programmable mirror array, the said support structure may be embodied as a frame or table, for example, which may be fixed or movable as required; and

A programmable LCD array. An example of such a construction is given in U.S. Pat. No. 5,229,872, which is incorporated herein by reference. As above, the support structure in this case may be embodied as a frame or table, for example, which may be fixed or movable as required.

For purposes of simplicity, the rest of this text may, at certain locations, specifically direct itself to examples involving a mask and mask table; however, the general principles discussed in such instances should be seen in the broader context of the patterning device as set forth here above.

Lithographic projection apparatus can be used, for example, in the manufacture of integrated circuits (ICs). In that case, the patterning device may generate a circuit pattern corresponding to an individual layer of the IC, and this pattern can be imaged onto a target portion (e.g. comprising one or more dies) on a substrate (silicon wafer) that has been coated with a layer of radiation-sensitive material (resist). In general, a single wafer will contain a whole network of adjacent target portions that are successively irradiated via the projection system, one at a time. In current apparatus, employing patterning by a mask on a mask table, a distinction can be made between two different types of machine. In one type of lithographic projection apparatus, each target portion is irradiated by exposing the entire mask pattern onto the target portion in one go; such an apparatus is commonly referred to as a wafer stepper or step-and-repeat apparatus. In an alternative apparatus—commonly referred to as a step-and-scan apparatus—each target portion is irradiated by progressively scanning the mask pattern under the projection beam in a given reference direction (the “scanning” direction) while synchronously scanning the substrate table parallel or anti-parallel to this direction; since, in general, the projection system will have a magnification factor M (generally <1), the speed V at which the substrate table is scanned will be a factor M times that at which the mask table is scanned. More information with regard to lithographic devices as here described can be gleaned, for example, from U.S. Pat. No. 6,046,792, incorporated herein by reference.

In a manufacturing process using a lithographic projection apparatus, a pattern (e.g. in a mask) is imaged onto a substrate that is at least partially covered by a layer of radiation-sensitive material (resist). Prior to this imaging step, the substrate may undergo various procedures, such as priming, resist coating and a soft bake. After exposure, the substrate may be subjected to other procedures, such as a post-exposure bake (PEB), development, a hard bake and measurement/inspection of the imaged features. This array of procedures is used as a basis to pattern an individual layer of a device, e.g. an integrated circuit (IC). Such a patterned layer may then undergo various processes such as etching, ion-implantation (doping), metallization, oxidation, chemical-mechanical polishing, etc., all intended to finish off an individual layer. If several layers are required, then the whole procedure, or a variant thereof, will have to be repeated for each new layer. Eventually, an array of devices will be present on the substrate (wafer). These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4, incorporated herein by reference.

For the sake of simplicity, the projection system may hereinafter be referred to as the “lens”. However, this term should be broadly interpreted as encompassing various types of projection system, including refractive optics, reflective optics, and catadioptric systems, for example. The radiation system may also include components operating according to any of these design types for directing, shaping or controlling the projection beam of radiation, and such components may also be referred to below, collectively or singularly, as a “lens”.

Furthermore, the lithographic apparatus may be of a type having two or more substrate tables (and/or two or more mask tables). In such “multiple stage” devices the additional tables may be used in parallel, or preparatory steps may be carried out on one or more tables while one or more other tables are being used for exposures. Dual stage lithographic apparatus are described, for example, in U.S. Pat. No. 5,969,441 and WO 98/40791, both incorporated herein by reference.

Although specific reference may be made in this text to the use of the apparatus according to the invention in the manufacture of integrated circuits, it should be explicitly understood that such an apparatus has many other possible applications. For example, it may be employed in the manufacture of integrated optical systems, guidance and detection patterns for magnetic domain memories, liquid-crystal display panels, thin-film magnetic heads, etc. The person skilled in the art will appreciate that, in the context of such alternative applications, any use of the terms “reticle”, “wafer” or “die” in this text should be considered as being replaced by the more general terms “mask”, “substrate” and “target portion”, respectively.

In the present document, the terms “radiation” and “projection beam” are used to encompass all types of electromagnetic radiation, including ultraviolet (UV) radiation (e.g. with a wavelength of 365, 248, 193, 157 or 126 nm) and extreme ultra-violet (EUV) radiation (e.g. having a wavelength in the range 5-20 nm).

For lithographic processing, the location of patterns in subsequent layers on the wafer should be as precise as possible for a correct definition of device features on the substrate, which features all should have sizes within specified tolerances. The overlay should be within well-defined tolerances for creating functional devices. To this end, the lithographic projection apparatus comprises an overlay measurement module which provides for determining the overlay of a pattern on the substrate with a mask pattern as defined in a resist layer on top of the pattern.

The overlay system typically performs the measurement by optical elements. The position of the mask pattern relative to the position of the pattern on the substrate is determined by measuring an optical response from an optical marker that is illuminated by an optical source. The signal generated by the optical marker is measured by a sensor arrangement. Using the output of the sensors the overlay can be derived.

Optical markers are used during microelectronic device processing (or IC processing) along the full manufacturing line. During the front end of line (FEOL), markers are used for overlay during manufacturing of transistor structures. At a later stage during the back end of line (BEOL), markers are needed for overlay of metallization structures, e.g. connect lines, and vias. It is noted that in both cases the integrity of the markers must be sufficient to meet the required accuracy of overlay.

In the prior art marker structures for overlay control are present in some area(s) of a substrate to allow for controlling the overlay of a mask pattern in a resist layer (after exposure and development) with further pattern already present on the substrate. A well-known structure for overlay control is a so-called overlay metrology target, which in this example, comprises a first structure consisting of 4 rectangular blocks as constituent parts arranged with their length along one of the sides of an imaginary square, and a second structure similar to, but smaller than, the first structure. To determine the overlay of patterns in two successive layers, one of the first and second structures is defined in the pattern in the first successive layer, the other one of the first and second structures is defined in the pattern in the resist layer for the second successive layer. In use, for both of the first and second structures the position (e.g., the gravity centre) is determined for example, by detection of the edges of the respective rectangular blocks within the first and second structures, or using a correlation technique with respect to a reference target. From the difference in the centre of gravity position of the first and second structures, the overlay of the two structures is determined. It is noted that in the prior art other overlay metrology targets, such as a box-in-box target, are also known.

In the prior art it is recognized that for proper processing the constituent parts of a marker structure, which typically consists of the same material as (parts of) device features, should generally have dimensions similar to the dimensions of features of microelectronic devices to avoid size-induced deviations during processing of integrated circuits, due to, for example, a micro-loading effect during a reactive ion etching process which may occur at device structures in the vicinity of a large marker area or due to size dependency of chemical-mechanical polishing (CMP) of structures.

U.S. Pat. No. 5,917,205 discloses photo-lithographic alignment marks based on circuit pattern features. Alignment marker structures are mimicked by a plurality of sub-elements which are ordered in such a way that their envelope corresponds to the marker structure. Furthermore, each sub-element has dimensions comparable to a critical feature size of a microelectronic device. Basically the solution to marker size induced processing deviations is by “chopping up” a large marker into many small-sized sub-elements which resemble features of a device (or “product”).

Although the processing deviations of the structures lessen and wafer quality improves, it is to be noted that the overlay of features depends also on the quality of the projection system. The projection system comprises lenses which each may have aberrations. Such aberrations are typically small and are reduced with each new lens design, but, since the device features to be imaged are becoming smaller with each new device generation, the relative influence of the optical aberrations is also increasing with each new device generation.

Moreover the distortion is dependent on the actual optical path that a light signal passing through an opening in a mask pattern (relating to a given feature) traverses in the projection system before impinging on the (resist coated) substrate.

Due to the dependency on the actually traversed optical path, the observed distortion of imaged features varies with the position of the features on the mask and is generally known as pattern-induced distortion (PID) or aberration-induced distortion (AID).

Furthermore the density of a pattern of small features also influences the amount of pattern induced distortion. For a dense part in the centre of a mask pattern the distortion will differ from the distortion caused by a less dense part at the edge of the mask pattern. Consequently, the distortion measured for an overlay structure, e.g. an overlay target at the outer periphery of a mask pattern, will differ from the distortion within the centre part of the mask pattern.

Typically the centre of the mask pattern will comprise the devices or products which are relevant to the semiconductor device manufacturer, and it therefore follows that such overlay control is not very effective in that the actual devices will have a distortion different from the distortion measured at the location of the overlay.

### SUMMARY OF THE INVENTION

It is an object of the present invention to provide a method to correct for overlay errors which are caused by pattern induced distortion in a projection system of a lithographic projection apparatus.

According to the present invention there is provided a method for modifying an image of a pattern during an imaging process, the pattern being arranged on a mask for imaging by a projection system on a surface, the image being an image formed from the pattern by a portion of the projection system, an imaging quality of said portion of the projection system being described by imaging quality parameters, and the projection system being adapted to adjust the image by image adjustment parameters, characterized in that the method comprises the steps of:
(a) determining an ideal image of the pattern;
(b) determining a simulated distorted image of the pattern based on said imaging quality parameters;
(c) determining a deviation between the simulated distorted image and the ideal image; and
(d) adapting said image adjustment parameters during said imaging process to minimize the deviation between the simulated distorted image and the ideal image.

Advantageously, this method allows the use of standard overlay metrology targets on a mask pattern in combination with product features with dimensions much smaller than the dimensions of the features of the overlay metrology target. The method uses information on the aberrations of the projection system to adapt the settings of the projection system in such a way that distortions of an image are counteracted. Both low-order aberrations, which cause image distortion effects that are independent of the optical path in the lens system to form the image, and high-order lens aberrations, which relate to distortion effects that depend on the optical path actually used in the lens system, can be corrected by such an arrangement.

In a particular embodiment of the invention said adaptation of said image adjustment parameters is optimised by providing for the aberrations to which the particular application is most sensitive to be compensated for according to an optimum requirement.

In a still further embodiment of the invention a further processing step is provided in which the aberrations to which associated metrology overlay and/or alignment marks are most sensitive are compensated for according to an optimum requirement. Since standard overlay metrology targets are subject to different distortion to product features with much smaller dimensions, due to the use of different optical paths and different regions of the projection lens system, the method is advantageously adapted to correct standard metrology target image distortion and product feature image distortion simultaneously.

In certain embodiments the adaptation of the image adjustment parameters is optimised on the basis of data indicative of the selected pattern, the mask type and the pupil plane filling. The pupil plane filling is determined by various parameters such as the illumination mode of the projection system, as well as the diffractive optical elements (DOE's) of the projection system, and is the property that, together with the aberrations, determines the lithographic performance. The adaptation of the image adjustment parameters may also be optimised on the basis of data indicative of the user-defined lithographic specification.

In one embodiment of the invention the adaptation of the image adjustment parameters comprises determination of image correction data for distortion coefficients by calculating settings for respective adjusting elements to obtain an image with minimal distortion, and using the image correction data as the image adjustment parameters for adjusting the adjusting elements.

In another embodiment of the invention said adaptation of said image adjustment parameters comprises determination of image correction data for distortion coefficients by (i) estimating, for each aberration type as defined by a respective Zernike coefficient, the sensitivity of an image feature to distortion with respect to the respective Zernike coefficient, (ii) determining a first combination of the sensitivities for the aberration types in a first direction in the image, and (iii) determining a second combination of the sensitivities for the aberration types in a second direction in the image, the second direction being perpendicular to the first direction, and using the image correction data as the image adjustment parameters for adjusting the projection system.

The image correction data may be determined during said imaging process in a step-and-repeat mode. Alternatively the image correction data may be determined on the basis of a slit coordinate during said imaging process in a step-and-scan mode.

The invention also provides apparatus for modifying an image of a pattern during an imaging process, said apparatus comprising a mask, a projection system, and a control system adapted to control and adjust machine parameters during execution of an imaging process and comprising a host processor, a memory for storing instructions and data, and an input/output device for handling signals transmitted to and received from actuators and sensors in said projection system, said host processor being connected to said memory for processing said instructions and data and to said input/output device for controlling said signals;
the pattern being arranged on said mask for imaging by the projection system on a surface, the image being an image formed from the pattern by a portion of the projection system, an imaging quality of said portion of the projection system being described by imaging quality parameters, and said projection system being adapted to adjust the image by image adjustment parameters;
characterized in that said electronic control system is adapted to carry out the following processing steps:
(a) determining an ideal image of the pattern;
(b) determining a simulated distorted image of the pattern based on said imaging quality parameters;
(c) determining a deviation between the simulated distorted image and the ideal image; and
(d) adapting said image adjustment parameters during said imaging process to minimize the deviation between the simulated distorted image and the ideal image.

The invention further provides a computer program product to be loaded by apparatus for modifying an image of a pattern during an imaging process, said apparatus comprising a mask, a projection system, and a control system adapted to control and adjust machine parameters during execution of an imaging process and comprising a host processor, a memory for storing instructions and data, and an input/output device for handling signals transmitted to and received from actuators and sensors in said projection system, said host processor being connected to said memory for processing said instructions and data and to said input/output device for controlling said signals;
the pattern being arranged on said mask for imaging by the projection system on a surface, the image being an image formed from the pattern by a portion of the projection system, an imaging quality of said portion of the projection system being described by imaging quality parameters, and said projection system being adapted to adjust the image by image adjustment parameters;
characterized in that said computer program product is adapted to carry out the following processing steps:
(a) determining an ideal image of the pattern;
(b) determining a simulated distorted image of the pattern based on said imaging quality parameters;
(c) determining a deviation between the simulated distorted image and the ideal image; and
(d) adapting said image adjustment parameters during said imaging process to minimize the deviation between the simulated distorted image and the ideal image.

The invention also provides lithographic projection apparatus comprising a radiation system for providing a projection beam of radiation, a support structure for supporting a patterning device, the patterning device serving to pattern the projection beam according to a pattern, a substrate table for holding a substrate, and a projection system for projecting the patterned beam onto a target portion of the substrate, the pattern being arranged on said patterning device for imaging by a projection system on a surface, the image being an image formed from the pattern by a portion of the projection system, an imaging quality of said portion of the projection system being described by imaging quality parameters, and said projection system being adapted to adjust the image by image adjustment parameters;
characterized in that said lithographic projection apparatus is arranged to carry out the following processing steps:
(a) determining an ideal image of the pattern;
(b) determining a simulated distorted image of the pattern based on said imaging quality parameters;
(c) determining a deviation between the simulated distorted image and the ideal image; and
(d) adapting said image adjustment parameters during said imaging process to minimize the deviation between the simulated distorted image and the ideal image.

### BRIEF DESCRIPTION OF THE DRAWINGS

Embodiments of the invention will now be described, by way of example only, with reference to the accompanying drawings, in which:

FIG. 1 depicts a lithographic projection apparatus comprising at least one marker structure;

FIG. 2 shows schematically a computer arrangement as used in an embodiment of the present invention;

FIG. 3 shows schematically a projection system;

FIG. 4 shows an exemplary map for total lens distortion of a projection system;

FIG. 5 shows exemplary pattern induced distortion data for product and overlay metrology features plotted as a function of slit co-ordinate;

FIG. 6 shows distortion data similar to that of FIG. 5 after applying a metrology-based correction;

FIGS. 6a and 7 are schematic diagrams of a development of the invention utilizing an IQEA model; and

FIG. 8 is a flow chart of the control steps to be carried out in implementing this development of the invention in a computer system.

### DETAILED DESCRIPTION OF THE EMBODIMENTS OF THE INVENTION

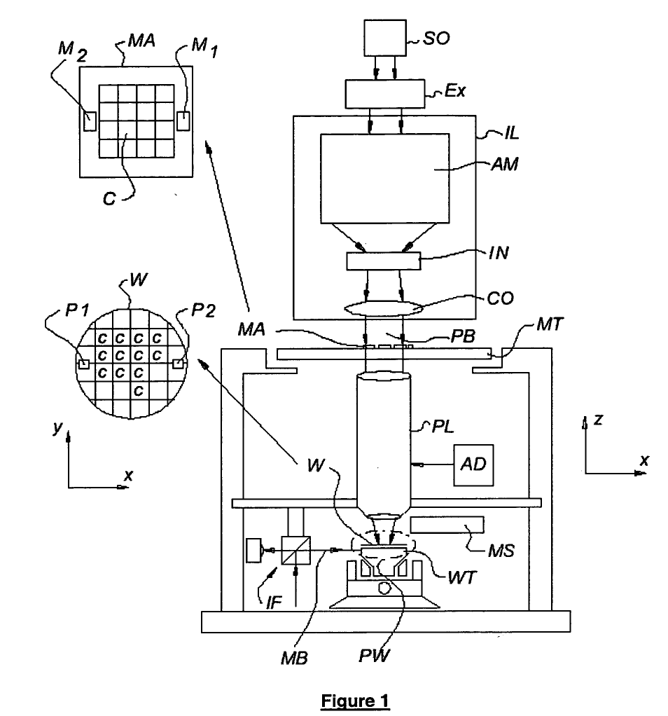

FIG. 1 schematically depicts lithographic projection apparatus comprising at least one marker structure in accordance with an embodiment of the invention. The apparatus comprises:
an illumination system IL for providing a projection beam PB of radiation (e.g. UV or EUV radiation). In this particular case, the radiation system also comprises a radiation source SO;
a first support structure MT (e.g. a mask table) for supporting a patterning device, MA (e.g. a mask) and connected to a first positioner (not shown) for accurately positioning the patterning device with respect to item PL;
a second support structure WT (e.g. a wafer table) for holding a substrate, W (e.g. a resist-coated silicon wafer) and connected to a second positioner PW for accurately positioning the substrate with respect to item PL; and
a projection system PL (e.g. a reflective projection lens) for imaging a pattern imported to the projection beam PB by patterning device MA onto a target portion C (e.g. comprising one or more dies) of the substrate W.

The projection system PL is provided with an actuating device AD for adapting the optical settings of the system. The operation of adapting the optical settings will be explained hereinafter in more detail.

As depicted here, the apparatus is of a transmissive type (i.e. has a transmissive mask). However the apparatus may alternatively be of a reflective type (with a reflective mask). Alternatively the apparatus may employ another kind of patterning device, such as a programmable mirror array of a type as referred to above.

The source SO (e.g. a mercury lamp or an excimer laser) produces a beam of radiation. This beam is fed into an illumination system (illuminator) IL, either directly or after having traversed conditioning elements, such as a beam expander Ex, for example. The illumination system IL further conditions the beam, and may comprise adjustable optical elements AM for setting the outer and/or inner radial extent (commonly referred to as σ-outer and σ-inner, respectively) of the intensity distribution of the beam PB. In addition, it will generally comprise various other components, such as an integrator IN and a condenser CO. In this way, the beam PB impinging on the mask MA has a desired uniformity and intensity distribution in its cross-section.

It should be noted with regard to FIG. 1 that the source SO may be within the housing of the lithographic projection apparatus (as is often the case when the source SO is a mercury lamp, for example), but that the source SO may also be remote from the lithographic projection apparatus, the beam which it produces being led into the apparatus (e.g. with the aid of suitable directing mirrors). This latter scenario is often the case when the source SO is an excimer laser. The present invention is applicable to both of these scenarios.

The beam PB is incident on the mask MA, which is held on the mask table MT. Having traversed the mask MA, the beam PB passes through the lens PL, which focuses the beam PB onto a target portion C of the substrate W. With the aid of the second positioner PW and interferometer IF, the substrate table WT can be moved accurately, e.g. so as to position different target portions C in the path of the beam PB. Similarly, the first positioner (acting on the mask table MT) can be used to accurately position the mask MA with respect to the path of the beam PB, e.g. after mechanical retrieval of the mask MA from a mask library, or during a scan. In general, movement of the object tables MT, WT will be realized with the aid of a long-stroke module (coarse positioning) and a short-stroke module (fine positioning), which are not explicitly shown in FIG. 1. However, in the case of a wafer stepper (as opposed to a step-and-scan apparatus) the mask table MT may just be connected to a short stroke actuator, or may be fixed. Mask MA and substrate W may be aligned using mask alignment marks M1, M2 and substrate alignment marks P1, P2.

The depicted apparatus can be used in two different modes:

1. In step mode, the mask table MT and the substrate table WT are kept essentially stationary, and an entire pattern imported to the beam PB is projected in one go (i.e. a single “flash”) onto a target portion C. The substrate table WT is then shifted in the X and/or Y directions so that a different target portion C can be irradiated by the beam PB; and

2. In scan mode, essentially the same scenario applies, except that a given target portion C is not exposed in a single “flash”. Instead, the mask table MT is movable in a given direction (the so-called “scan direction”, e.g. the Y-direction) with a speed ν, so that the projection beam PB is caused to scan over a mask image; concurrently, the substrate table WT is simultaneously moved in the same or opposite direction at a speed V=M ν, in which M is the magnification of the lens PL (typically, M=¼ or ⅕). In this manner, a relatively large target portion C can be exposed, without having to compromise on resolution.

3. In another mode, the mask table MT is kept essentially stationary holding a programmable patterning device, and the substrate table WT is moved or scanned while a pattern imparted to the projection beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In a non-illustrated variant embodiment the substrate table is replaced by a twin-scan arrangement comprising two scan stages to which the wafers are supplied successively so that, whilst one of the wafers is being exposed in one or other of the different modes described above, another of the wafers is being subjected to the necessary measurements to be carried out prior to exposure, with a view to decreasing the amount of time that each wafer is within the exposure zone and thus increasing the throughput of the apparatus. More generally, the lithographic apparatus may be of a type having two or more substrate tables (and/or two or more mask tables). In such multiple stage machines the additional tables may be used in parallel, or preparatory steps may be carried out on one or more tables while one or more other tables are being used for exposure.

The interferometer typically can comprise a light source, such as a laser (not shown), and one or more interferometers for determining some information (e.g. position, alignment, etc.) regarding an object to be measured, such as a substrate or a stage. In FIG. 1, a single interferometer IF is schematically depicted by way of example. The light source (laser) produces a metrology beam MB which is routed to the interferometer IF by one or more beam manipulators. In the case where more than one interferometer is present, the metrology beam is shared between them, by using optics that split the metrology beam into separate beams for the different interferometers.

A substrate alignment system MS for alignment of a substrate on the table WT with a mask on the mask table MT, is schematically shown at an exemplary location close to the table WT, and comprises at least one light source which generates a light beam aimed at a marker structure on the substrate W and at least one sensor device which detects an optical signal from that marker structure. It is to be noted that the location of the substrate alignment system MS depends on design conditions which may vary with the actual type of lithographic projection apparatus.

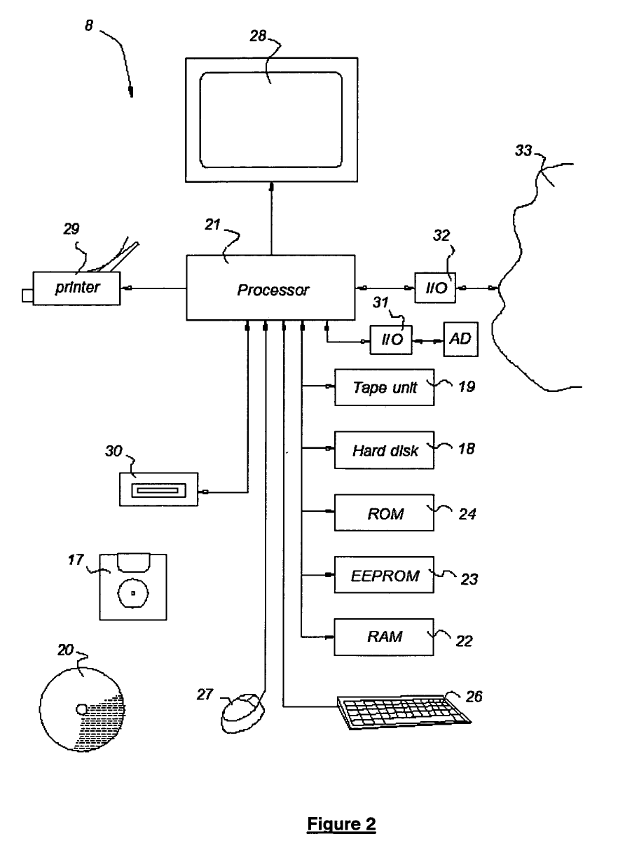

Furthermore the lithographic projection apparatus comprises an electronic control system that is capable of controlling and adjusting machine parameters during execution of an imaging and exposure process. An exemplary electronic control system is schematically illustrated in FIG. 2. It is noted that the lithographic projection apparatus comprises sophisticated computing resources for controlling functions of the lithographic projection apparatus with high accuracy. FIG. 2 illustrates only the functionality of the computing resources in relation to the present invention. The computing resources may comprise additional systems and subsystems which are not illustrated here.

The overall aberration can be decomposed into a number of different types of aberrations, such as spherical aberration, astigmatism and so on. The overall aberration is the sum of these different aberrations, each with a particular magnitude given by a coefficient. Aberration results in a deformation in the wave front and different types of aberration represent different functions by which the wave front is deformed. These functions may take the form of the product of a polynomial in the radial position r and an angular function in sine or cosine of mθ, where r and θ are polar coordinates and m is an integer. One such functional expansion is the Zernike expansion in which each Zernike polynomial represents a different type of aberration and the contribution of each aberration is given by a Zernike coefficient, as will be described in more detail below.

Particular types of aberration, such as focus offset, and aberrations with even values of m (or m=0) in the angular functions dependent on mθ, can be compensated for by way of image parameters for effecting adjustment of the apparatus in such a manner as to displace the projected image in the vertical (z) direction. Other aberrations, such as coma, and aberrations with an odd value of m can be compensated for by way of image parameters for effecting adjustment of the apparatus in such a manner as to produce a lateral shift in the image position in the horizontal plane (the x,y-plane).

The best-focus (BF) position, i.e. z-position of the image, can be measured using the actual lithographic projection apparatus. The best-focus position is the z-position with maximum contrast, for example the position as defined by the maximum of a sixth-order polynomial fit to the contrast-versus-position curve as the position is moved from defocus, through focus and on to defocus. The best-focus can be determined experimentally using known techniques, such as the technique known as “FOCAL” (described below); alternatively, one may directly measure the aerial image, for example by using a transmission image sensor (TIS) (described below) or commercial focus monitor.

FOCAL is an acronym for focus calibration by using alignment. It is a best-focus measurement technique for completely determining information about the focal plane using the alignment system of the lithographic apparatus. A special, asymmetrically segmented alignment mark is imaged through focus on to a resist coated wafer. The position of this imaged mark (latent or developed) can be measured by the alignment system. Due to the asymmetric segmentation, the position measured by the alignment system will depend on the defocus used during exposure, thus allowing determination of the best-focus position. By distributing these marks over the whole image field and using different orientation for the segmentation, the complete focal plane for several structure orientations can be measured. This technique is described in more detail in U.S. Pat. No. 5,674,650 incorporated herein by reference.

One or more transmission image sensors (TIS) can be used to determine the lateral position and best focus position (i.e. horizontal and vertical position) of the projected image from the mask under the projection lens. A transmission image sensor (TIS) is inset into a physical reference surface associated with the substrate table (WT). In a particular embodiment, two sensors are mounted on fiducial plates mounted to the substrate-bearing surface of the substrate table (WT), at diagonally opposite positions outside the area covered by the wafer W, and are used to determine directly the vertical (and horizontal) position of the aerial image of the projected image. To determine the position of the focal plane, the projection lens projects into space an image of a pattern provided on the mask MA (or on a mask table fiducial plate) and having contrasting light and dark regions. The substrate stage is then scanned horizontally (in one or possibly two directions, e.g. the x and y directions) and vertically so that the aperture of the TIS passes through the space where the aerial image is expected to be. As the TIS aperture passes through the light and dark portions of the image of the TIS pattern, the output of the photodetector will fluctuate (a Moiré effect). The vertical level at which the rate of change of amplitude of the photodetector output is highest indicates the level at which the image of TIS pattern has the greatest contrast and hence indicates the plane of optimum focus. The x, y-positions of the TIS aperture at which the rate of change of amplitude of the photodetector output during said horizontal scan is highest, are indicative of the aerial lateral position of the image. An example of a TIS detection arrangement of this type is described in greater detail in U.S. Pat. No. 4,540,277 incorporated herein by reference.

The measurement of other imaging parameters is described in U.S. Pat. No. 6,563,564.

Other techniques can also be used to analyze the image. For example a so-called ILIAS sensing arrangement as described in WO 01/63233 may be used.

From these measurements of the image position, it is possible to obtain the Zernike coefficients of the different forms of aberration. This is explained more fully in, for example, European Patent Application No. EP 1128217A2 incorporated herein by reference.

FIG. 2 shows schematically a computer arrangement 8 as used in a particular embodiment of the present invention comprising a host processor 21 with peripherals. The host processor 21 is connected to memory units 18, 19, 22, 23, 24 which store instructions and data, one or more reading units 30 (to read, e.g. floppy disks 17, CD ROM's 20, DVD's, etc.), input devices, such as a keyboard 26 and a mouse 27, and output devices, such as a monitor 28 and a printer 29. Other input devices, like a trackball, a touch screen or a scanner, as well as other output devices, may be provided.

An input/output (I/O) device 31 is provided for connection to the lithographic projection apparatus. The I/O device 31 is arranged for handling signals transmitted to and received from actuators and sensors, which take part in controlling of the projection system PL in accordance with the present invention. Further, a network I/O device 32 is provided for a connection to a network 33.

The memory units shown comprise a RAM 22, an (E)EPROM 23, a ROM 24, a tape unit 19, and a hard disk 18. However, it should be understood that there may be provided more and/or other memory units known to persons skilled in the art. Moreover, one or more of them may be physically located remote from the processor 21, if required. The processor 21 is shown as one box, however, it may comprise several processing units functioning in parallel or controlled by one main processor, that may be located remotely from one another, as is known to persons skilled in the art.

Furthermore, the computer arrangement 8 may be located remotely from the location of the lithographic projection apparatus and provide its functions to the lithographic projection apparatus over a further network connection.

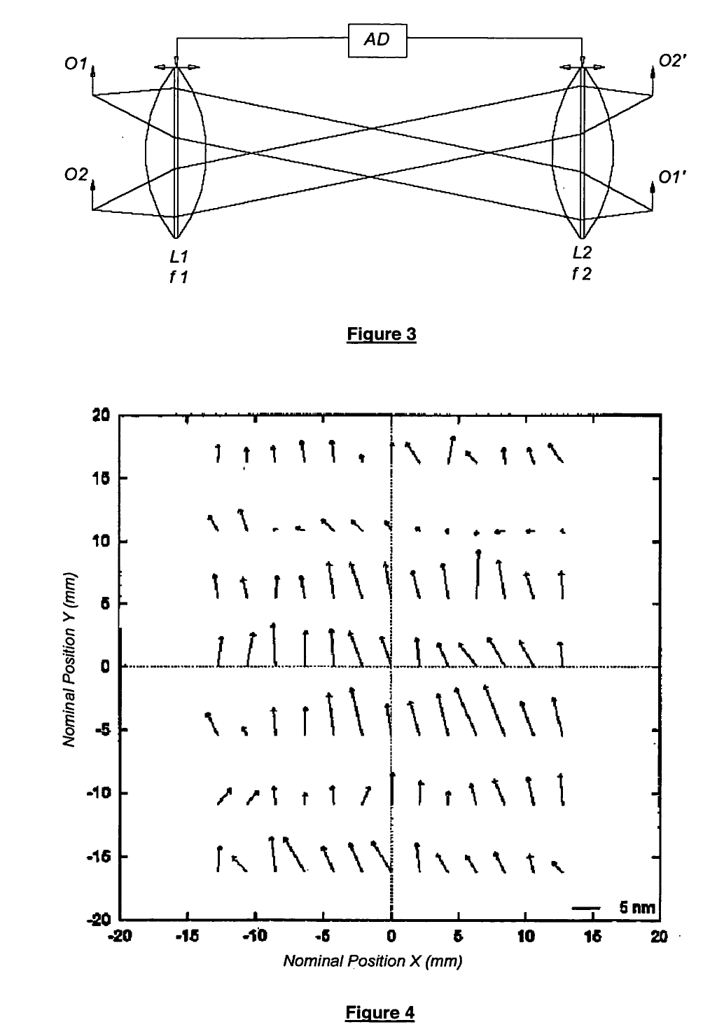

FIG. 3 shows schematically a projection system for a lithographic projection apparatus as shown in FIG. 1. The projection system can be schematically depicted as a telescope comprising as optical elements at least two lenses, namely a first lens L1 with a first focus f1, and a second lens L2 with a second focus f2. In this exemplary arrangement the first and second lenses L1, L2 are convex lenses. Persons skilled in the art will appreciate that a projection system for a lithographic projection apparatus may comprise a plurality of convex and concave lenses.

The projection system is provided with an actuating device AD which is capable of adapting the optical settings of the projection system by manipulating the optical elements within the projection system. The actuating device AD is provided with input and output ports for exchanging control signals with a control system (not shown).

In use, a first object O1 which is located in the object plane is imaged as a first image O1′ on a reference plane. The first object O1 is a first geometrical pattern portion for forming a first feature on the substrate in the reference plane. The first feature typically is (a portion of) a microelectronic device to be formed, e.g. a transistor. Typically a transistor has a lateral size of sub-micron dimension. Accordingly, the first object has a lateral size in the mask pattern with a dimension magnified by the magnification factor M of the projection system.

Due to the (still) small finite size of the first object O1, a light beam passing the mask portion of the first object traverses only through a first limited portion of the aperture of the lenses L1 and L2 of the projection system. This effect is indicated by the light paths extending from O1 towards the image O1′.

Likewise, a second object O2 is imaged as a second image O2′ on the reference plane. In this example, the second object O2 has a size comparable to the size of the first object O1, and is imaged by the light beam traversing through only a second limited portion of the aperture of the lenses L1 and L2 of the projection system. However, due to the different location of the second object O2 in the mask pattern, the second limited portion of the projection system used for imaging the second object O2 is different from the first limited portion used for imaging the first object O1. Since lens aberrations vary with the location on the lens, the image of the first object O1 is subjected to different pattern induced distortion than the image of the second object O2.

It will be appreciated that the separation between the first and second objects O1 and O2 on the mask pattern influences the degree to which the pattern induced distortion is different for the first and second images O1′ and O2′. When the first and second objects O1 and O2 are located at a relatively close distance apart, the portions of the projection system used may be almost identical. At larger distances, the distortion may be different (depending on local variation in the projection system) since the portions of the projection system used for creating the first and second images O1′ and O2′ will be different.

This variation in distortion for first and second objects O1 and O2 within a single mask pattern may be disadvantageous in use. Such variation in distortion may also occur between first and second objects imaged by different masks. In that case, the variation in distortion adds to the overlay error of the masks.

FIG. 4 shows an exemplary map for total lens distortion of a projection system. The total lens distortion relates not only to the lens aberrations but also to reticle errors, scanning errors, etc.

As explained above, the lens aberrations cause image displacement which varies as a function of the nominal position in the image plane (and thus image distortion). A map of exemplary image displacements in the xy-plane of the image is shown as a distortion field indicated by a vector representation in FIG. 4. The direction of each vector indicates the direction of the distortion at the location of the vector, the length of each vector indicating the magnitude of the distortion at the location of the respective vector.

It is known that a geometrical distortion model can be used to describe the distortion in X- and Y-directions, i.e. dx and dy, respectively.

The geometrical distortion at each position x, y is defined as the deviation from the expected position (i.e. the position of the image after projection by an ideal projection system without any distortion):
dx=f(x,y)=Tₓ+Mₓx+Rₓy+D₃x³+Rs (1)
dy=f(x,y)=T_{y}+M_{y}y+R_{y}x+Rs (2)
where Tₓ, T_{y} represent a distortion offset, Mₓ, M_{y} are linear distortion coefficients and Rₓ, R_{y} are rotation coefficients for the x- and y-directions respectively. D₃ is a cubic distortion coefficient, and Rs is a residual term.

It should be noted that Tₓ, T_{y}, Mₓ, M_{y}, Rₓ, R_{y}, and D₃ are geometry-related coefficients which can be adapted by the projection system by a change of settings of respective optical elements within the projection system and other adjustable elements, such as the mask and substrate tables, to change the geometry of an image of an object.

In addition to the distortions of equations (1) and (2), which reflect low-order lens aberrations, distortions caused by high-order lens aberrations also exist. Typically low-order lens aberrations relate to distortion effects which are independent of the pupil plane filling of the image, whereas high-order lens aberrations relate to distortion effects which depend on the actually used pupil plane filling of the image in the lens system.

The interactions between the pupil plane filling (which is dependent on inter alia the shape and size of features in a mask pattern and the illumination mode of the projection system) and the distortion due to higher order lens aberrations generate pattern induced distortion of features.

Lens aberrations are commonly described by Zernike coefficients, which each relate to a specific type of aberration. The description of lens aberrations by Zernike coefficients is well known to persons skilled in the art and is discussed in more detail below. Reference may be made to EP 1128217A2 for a fuller description of such Zernike coefficients and the manner in which they are measured.

FIG. 5 shows exemplary measured pattern induced distortion (PID) data for product and overlay metrology features respectively. For a lithographic projection apparatus which applies an imaging process by scanning a slit across a mask, the average distortion across the slit can be obtained from the data of FIG. 4. The slit extends in the X-direction, and the scanning direction is in the Y-direction. In FIG. 5 the average distortion dx of a relatively small-sized object product feature in the x-direction is plotted by a line interlinking points denoted by solid diamond symbols as a function of the scanning direction y. Furthermore, the distortion dxₒᵥ of an overlay structure, which is relatively large in size, is plotted as a line interlinking points denoted by open square symbols. It should be noted that no overlay correction has been applied.

From FIG. 5 it is clear that pattern induced distortion is dependent on the size of the object being imaged. The pattern induced distortion of the small-sized product feature in this case differs from the distortion of the relatively larger overlay structure.

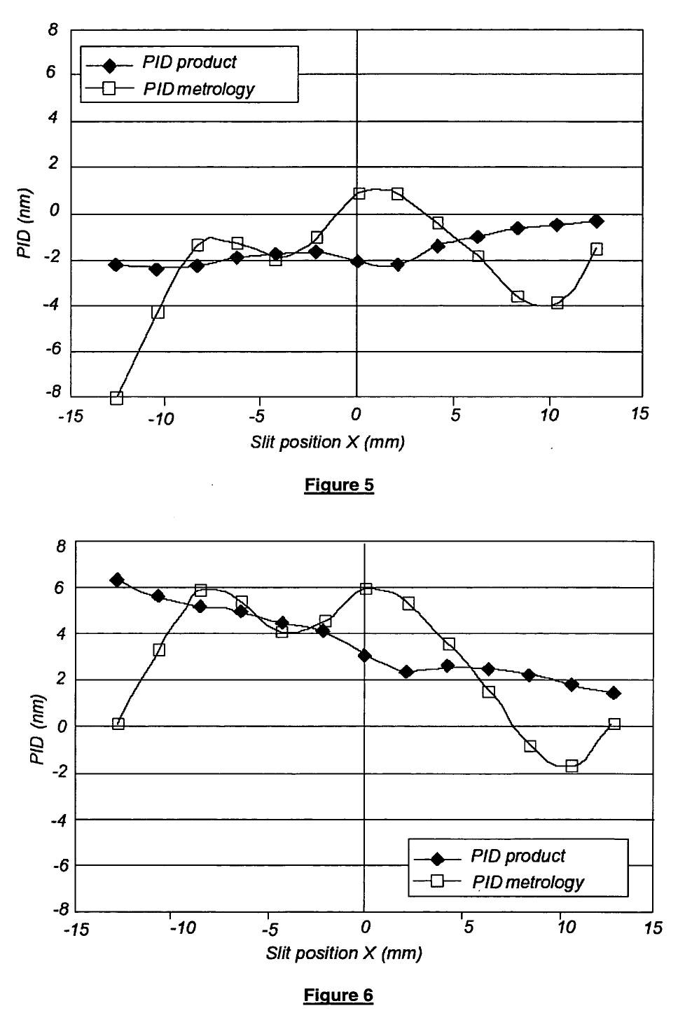

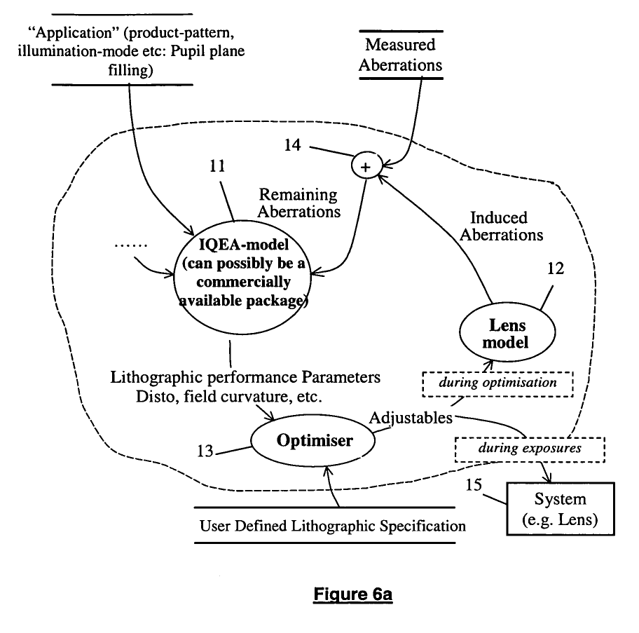

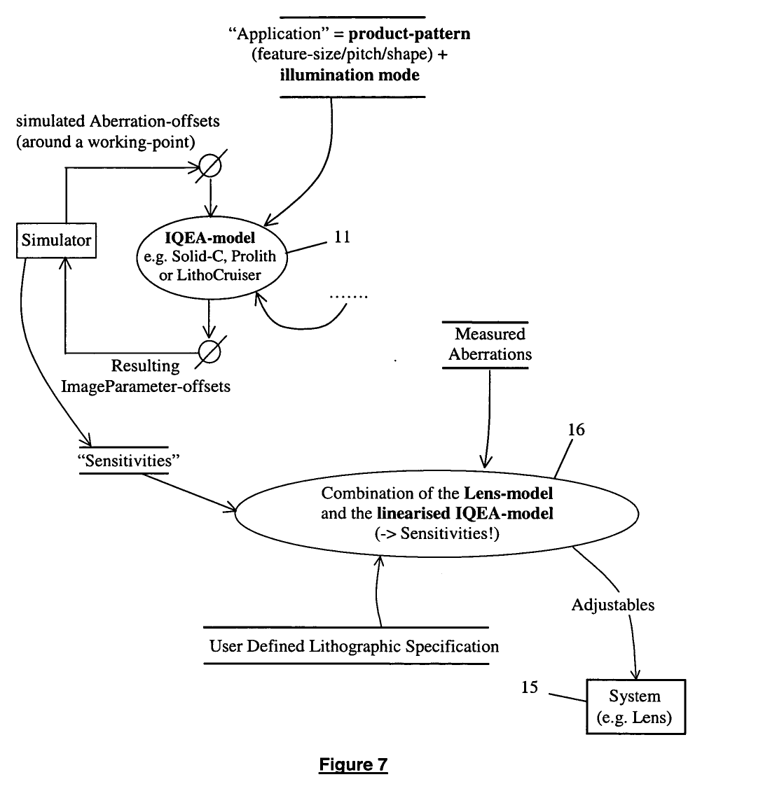

FIG. 6 shows the pattern induced distortion data of FIG. 5 for the product and overlay metrology features after applying a metrology-based correction, the plotted lines with the same shared symbols referring to the same entities as in the preceding FIG. 5.

In this example from the prior art, a correction of the overlay of product features based on the distortion measured for the overlay marker (dxₒᵥ) by taking the linear difference between the two outer values of dxₒᵥ will be incorrect. Basically, such a correction is based on translation and/or magnification of the image. Although not shown in this example, the corrected overlay for the product features will in many cases be worse than the uncorrected product feature overlay, in spite of the fact that the overlay of the overlay structure itself is improved. The outer edges of the overlay structure have a pattern induced distortion of zero (in the shown x-direction).

In the present invention, the pattern induced distortion of a feature to be imaged is minimized as a function of the distortion caused by the pupil plane filling and lens aberrations that contribute to the distortion for that particular feature.

The computer arrangement 8 of the present invention is capable of controlling and adjusting the settings of the projection system in such a way that, during an exposure, the overlay displacement of features is as low as possible.

To this end, the computer arrangement 8 uses information derived from mask pattern data, from data on high-order lens aberrations and from the resulting parameter values (Tₓ, T_{y}, Mₓ, M_{y}, Rₓ, R_{y}, and D3) of equations (1) and (2). The mask pattern data relate to data which describe the pattern of features on the imaging mask. The lens aberration data are derived from measurements performed on the projection system PL of the lithographic projection apparatus.

The processor 21 is capable of performing computations on the mask pattern data, and on the data on high-order lens aberrations and of performing, based on these computations and on the parameter values (Tₓ, T_{y}, Mₓ, M_{y}, Rₓ, R_{y}, and D3) of equations (1) and (2), corrections of the settings of the projection system to minimize the pattern induced distortion for the given mask pattern.

The procedure for these computations will be explained in more detail below. As a first step the lens aberrations measured for the projection system need to be described, for example in terms of Zernike coefficients. Next an aerial image of a given mask pattern is calculated. A diffraction model is used to compute an ideal aerial image, free of any pattern induced distortion, and also a deformed (projection of the) aerial image for the given pattern with distortion due to aberrations (Zernike coefficients). Finally, for each co-ordinate of the ‘projected’ aerial image, the local distortion (dx, dy) at each co-ordinate is derived, by determining the deviation between the ideal image and the deformed image of the mask pattern.

The correction of the aerial image for pattern induced distortion can be achieved in various ways:

1) Since the image can be modified at each co-ordinate by adapting the machine parameters which correct the geometrical distortion coefficients Tₓ, T_{y}, Mₓ, M_{y}, Rₓ, R_{y}, and D3, a full computation of the machine settings at each co-ordinate is performed. This requires a comprehensive computation/simulation method on high-end hardware. The resulting imaging correction data for the geometrical distortion coefficients Tₓ, T_{y}, Mₓ, M_{y}, Rₓ, R_{y}, and D3 from this computation can be used to adapt the settings of the projection system at each co-ordinate of the image during the processing run of the lithographic projection apparatus. The computation may be executed before or during the processing run.

If the computation is done before the processing run, the imaging correction data will be stored in the memory of the computer arrangement 8, and will be retrieved during the processing run and used to adapt the projection system by an on-line adaptation procedure which adapts the projection system settings during the processing run in accordance with the parameters for pattern induced distortion as given by equations (1) and (2). Alternatively, the computation and the adaptation of the projection system (based on the results of the computation) are done in real-time.

2) Alternatively a linear estimation computation model can be used that implements an adaptation of projection system settings based on a linear combination of the sensitivities of the image to distortion with respect to all of the Zernike coefficients. Basically, a distortion of an ideal pattern feature with a given ideal centroid position will relatively shift the centroid position. For the different types of distortion as defined by the Zernike coefficients, the sensitivities of a given pattern feature to distortion will differ, but can be calculated based on a distortion map as shown in FIG. 3 or 4, depending on a “coordinate by coordinate” or “slit coordinate” based approach.

Furthermore, the sensitivity to a given distortion type varies with the shape of the (basic) pattern feature to be imaged. Therefore the linear estimation computation model computes (for example in an off-line mode) the pattern induced distortion parameters for a variety of pattern features (variation of shape and size) in combination with the local lens aberrations of the projection system. Also, the illumination mode and mask type (i.e. the pupil plane filling) are taken into account.

Using the linear estimation computation model the distortion (dx, dy) on a co-ordinate (x, y) is described by:
dx(x,y)=ΣZᵢ(x,y)·Sᵢ (3)
i=7, 10, 14, . . .
   dy(x,y)=93 Zᵢ(x,y)·Sᵢ (4)
i=8, 11, 15, . . .
   where Zᵢ is a Zernike coefficient of i^{th} order, Sᵢ is a sensitivity coefficient for a given Zernike coefficient Zᵢ, with the x-distortion and the y-distortion each being described by a series of Zernike coefficients. The Zernike coefficients depend on the x, y coordinate. The sensitivities Sᵢ basically depend on the pupil plane filling (depending on pattern, illumination mode, etc.). It should be noted that this model is only valid for illumination that is symmetrical with respect to the x and y axes. For cases in which the illumination is not symmetrical the relevant model will include all Zi coefficients.

The results of the computations of equations (3) and (4) are stored in the memory of the computer arrangement 8 in one or more databases as imaging correction data. The imaging correction data can be determined for any given pupil plane filling (that is any combination of pattern feature type and size, illumination setting, mask type, etc.). The one or more databases may hold imaging correction data as a function of each of such combinations.

During the lithographic processing run, the imaging correction data are retrieved from the memory. The projection system settings are adapted in accordance with a combination of pattern distortion parameters, namely the type and size of the pattern feature to be imaged, the actual lens aberrations co-ordinate and the actual pupil plane filling for that pattern feature. The imaging correction data (based on the combination of actual pattern distortion parameters) can be made available from the database through information in the job data file for the processing run to an on-line adaptation procedure. The on-line adaptation procedure adapts, by way of I/O device 31, the projection system settings during the processing run in accordance with the imaging correction parameters for pattern induced distortion as given by equations (3) and (4).

This approach may be advantageous in circumstances where a user of lithographic projection apparatus utilizing the system and method according to the present invention intends to have a minimal interaction between equipment and processing personnel, and is the approach adopted in the more detailed description of a linear estimation or linearised IQEA model that follows. The calculation of the sensitivities can be done off-line and these can directly be integrated into the lens model.

3) A further alternative is a combination of a comprehensive computation and a linear estimation. This approach is advantageous for situations where the linear estimation model suffers from too large an inaccuracy. Such a situation may occur in some cases (i.e. combinations of the type and size of the pattern feature to be imaged, the actual lens aberrations co-ordinate and the actual pupil plane filling for that pattern feature) where appreciable cross-terms may exist between various Zernike coefficients. This may, for example, occur for some critical parts in certain patterns with certain combinations of pattern features. This last alternative may initially run as a linear estimation computation as described above, but, for a critical part of a given combination of pattern, lens aberrations and pupil plane filling where one or more appreciable cross-terms are expected, a comprehensive computation may be performed for that particular critical part.

Again, during the lithographic processing run, the combination of actual imaging correction parameters can be made available from the database through information in the job data file for the processing run to an on-line adaptation procedure. The on-line adaptation procedure adapts the projection system settings during the processing run in accordance with the imaging correction parameters for pattern induced distortion as given by equations sets (1), (2) and/or (3), (4).

The correction of the aerial image for pattern induced distortion and the on-line adaptation procedure are carried out by the computer arrangement 8 of the electronic control system. The computations are performed by the processor 21, data relating to correction parameters for the projection system being stored in the memory units of the computer arrangement. The processor 21 determines the imaging correction parameters and instructs the I/Q device 31 to transmit imaging correction signals to the actuating device AD of the projection system which comprises sensors and actuators for correcting the pattern induced distortion during the processing run.

It should be noted that the computer arrangement 8 may receive status signals from the lithographic projection apparatus which relate to the status and/or the settings of the projection system and/or other parts of the lithographic projection apparatus. As will be appreciated by persons skilled in the art, the status signals may influence the timing and/or response of the electronic control system. These signals are however not discussed here.

The above description is concerned with the control of the projection system settings to correct for overlay errors caused by lens aberration, such errors being known as pattern induced distortion. However adjustment of the projection system settings to minimize such pattern induced distortion will inherently mean that other imaging parameters, such as focus plane, adjustable aberrations and related imaging parameters, are not optimal, and as a result non-optimal imaging performance of the system is produced.

In a development of the invention therefore, the control and adjustment of the settings of the projection system is adapted to take account of the relevant (focus and imaging) product aberration sensitivities in addition to the overlay parameters. Such overall optimisation of the projection system settings makes use of a so-called image quality effects of aberrations (IQEA) model. Normally it would be difficult to find projection system settings that would be optimal for all performance parameters during the lithographic processing run. Accordingly the control arrangement may be set to the user's selected specification in terms of the parameters to be optimized, such as distortion error, etc. for different applications, namely for different illumination settings, mask features, etc. The settings may be changed for each different image and/or different layer of the product. By use of this IQEA model the projection system may be set to its optimal performance not only in respect of the XY-plane by also in the Z direction (normal to the XY-plane) and with respect to general imaging parameters, according to the performance parameters specified by the user for the required application.

The overall aberration of the projection system can be decomposed into a number of different types of aberration, such as spherical aberration, astigmatism and so on. The overall aberration is the sum of these different aberrations, each with a particular magnitude given by a coefficient. Aberration results in a deformation in the wave front and different types of aberration represent different functions by which the wave front is deformed. These functions may take the form of the product of a polynomial in the radial position r and an angular function in sine or cosine of mθ, where r and θ are polar coordinates and m is an integer. One such functional expansion is the Zernike expansion in which each Zernike polynomial represents a different type of aberration and the contribution of each aberration is given by a Zernike coefficient:

$$W ( ρ , θ ) = {\sum }_{n = 0}^{N} {\sum }_{{l = - n}_{step 2}}^{n} {A}_{n , l} \cdot {R}_{n}^{l} ( ρ ) \cdot {ⅇ}^{ⅈ \cdot l \cdot θ} \qquad ( 1 )$$

where
W is the phase distribution in the pupil plane, as function of position in the pupil [nm]
A_{n,l} is the aberration or Zernike coefficient [nm]
Rₙ^{l} is a polynomial of order n, and dependent on 1.
ρ is the radius in the pupil plane [units of NA]
θ is the angle in the pupil [rad]
n is the power of ρ (0≦n≦N)
N is the order of the pupil expansion
l is the order of θ (n+1=even and −n≦1≦n)

The aberration coefficient A_{n,1} is usually written as Zernike coefficient Zᵢ:
A_{n,1}=aᵢ·Zᵢ, (2)
where
aᵢ is a scaling factor
i is n²+n+1+1

The aberrations and thus also the Zernike coefficients are a function of the position in the image plane: Zᵢ=Zᵢ(X,Y). However, in a scanner the aberrations in the y-direction are averaged out during the scanned exposure, so that Zᵢ(X,Y) becomes \overline{Z}ᵢ(X) (which is usually just referred to as Zᵢ(X)).

The function of the aberrations (Zernike coefficient) across the image plane can in turn be described by a simple series expansion:
Zᵢ(X)=Zᵢ_{_{—}}₀+Zᵢ_{_{—}}₁·X+Zᵢ_{_{—}}₂·X²+Zᵢ_{_{—}}₃·X³+Zᵢ_{_{—}}ᵣₑₛ(X), (3)
where Zᵢ(X) is described as the sum of a constant term (with coefficient Zᵢ_{_{—}}₀), a linear term (with coefficient Zᵢ_{_{—}}₁), etc. and a remaining term or residuals (Zᵢ_{_{—}}ᵣₑₛ).

The linear and third order terms of the low order odd aberrations (Z₂_{_{—}}₁, Z₂_{_{—}}₃) are usually referred to as the magnification and third order distortion. However, there are also for instance linear terms of higher order odd aberrations (eg. Z₇_{_{—}}₁ or coma tilt) which have a magnification effect (but depending on the exposed image, illumination setting and mask type). The second order of the lower order even aberration (Z₄_{_{—}}₂) is usually referred to as the field curvature.

A so-called lens model is used to calculate the lens settings (adjustable lens element positions) that give optimal lithographic performance. For instance the lens of one particular system is able to adjust the following parameters:
Z₂_{_{—}}₁, Z₂_{_{—}}₃, Z₄_{_{—}}₂, Z₇_{_{—}}₁, Z₉_{_{—}}₀, Z₁₄_{_{—}}₁, Z₁₆_{_{—}}₀

The following equations represent a simplified example of such a lens model:
Z₂_{_{—}}₁=A*E1+B*E2+C*E3
Z₇_{_{—}}₁=D*E1+F*E2+G*E3
Z₉_{_{—}}₀=H*E1+K*E2+N*E3
Z₁₄_{_{—}}₁=P*E1+Q*E2+R*E3 (4)
or in matrix notation:

$${\overline{Z}}_{adj} = ( \begin{matrix}{Z}_{2 \_ 1} \\ {Z}_{7 \_ 1} \\ {Z}_{9 \_ 0} \\ {Z}_{14 \_ 1}\end{matrix} ) = ( \begin{matrix}A & B & C \\ D & F & G \\ H & K & N \\ P & Q & R\end{matrix} ) \cdot ( \begin{matrix}E1 \\ E2 \\ E3\end{matrix} ) = M \cdot \overline{E} \qquad ( 5 )$$

where M is the dependencies matrix and \overline{E} is the lens element position vector.

The IQEA model calculates, from the characteristics of the product features and the illumination settings used, the so-called sensitivities (Sᵢ) for the different aberration coefficients (Zᵢ). This is done by using commercial packages, such as Prolith, Solid-C or Lithocruiser (from ASML Masktools), that are able to calculate the projected aerial image and/or resist pattern based on the characteristics of the feature, mask type, the illumination setting, and characteristics of the illumination and projection system. From the aerial image and/or simulated resist pattern the relevant lithographic errors can be calculated, such as X-displacement (the distribution of X- and Y-displacement errors being usually referred to as distortion), Z-displacement (called defocus and the distribution of Z-displacement errors being usually referred as focal plane deviation), CD difference (critical dimension difference for brick-wall features), left-right asymmetry, H-V litho errors, etc. The sensitivities are calculated by dividing the calculated error by the amount of aberration put into the simulator. This is done for all the relevant lithographic errors and aberrations (expressed in Zernikes coefficients).

By multiplying the calculated sensitivities by the aberration coefficients of the lens, the lithographic errors of the system are obtained across the image field. The distortion in the X-direction of a certain feature exposed with a certain illumination setting becomes:

$$dx ( X ) = {\sum }_{i} {Z}_{i} ( X ) \cdot {S}_{i} \\ ( i = 2 , 7 , 10 , 14 , 19 , 23 , 26 , 30 , and 34 ) . \qquad ( 6 )$$

And the defocus (dF) across the slit (for a vertical feature) becomes:

$$dF ( X ) = {\sum }_{i} {Z}_{i} ( X ) \cdot {S}_{i} \\ ( i = 4 , 5 , 9 , 12 , 16 , 17 , 21 , 25 , 28 , 32 , 36 and 37 ) . \qquad ( 7 )$$

Depending on the user defined lithographic specification, other lithographic errors also need to be taken into account. In general most lithographic errors can be written as:

$$\begin{matrix}E ( X ) = {\sum }_{i} {Z}_{i} ( X ) \cdot {S}_{i} & ( i = 2 , 3 , … 37 ) .\end{matrix} \qquad ( 8 )$$

If the lens model is used without also applying the IQEA model, all the image parameters (in this example Z2_{—}1, Z7_{—}1, Z9_{—}0 and Z14_{—}1) are optimised at the same time. Because there are less lens elements to adjust than there are parameters to optimise, the total system may be placed in the optimum state but the individual image parameters may not be optimal for the particular application. Furthermore the optimal state for all tunable parameters together might not give the optimal performance for a certain application.

By combining the IQEA model with the lens model, it is possible to optimise the lens model for the appropriate aberrations/applications.

For example, two possible methods for combining the lens model and the IQEA model are discussed below: The simplest method for combining the two models is by applying the calculated sensitivities (Sᵢ) from the IQEA model in the lens model:

$$\begin{matrix}{( {\overline{Z}}^{′} )}_{adj} = ( \begin{matrix}{Z}_{2 \_ 1}^{′} \\ {Z}_{7 \_ 1}^{′} \\ {Z}_{9 \_ 0}^{′} \\ {Z}_{14 \_ 1}^{′}\end{matrix} ) = ( \begin{matrix}{Z}_{2 \_ 1} \cdot {S}_{2} \\ {Z}_{7 \_ 1} \cdot {S}_{7} \\ {Z}_{9 \_ 0} \cdot {S}_{9} \\ {Z}_{14 \_ 1} \cdot {S}_{14}\end{matrix} ) \\ = ( \begin{matrix}A \cdot {S}_{2} & B \cdot {S}_{2} & C \cdot {S}_{2} \\ D \cdot {S}_{7} & F \cdot {S}_{7} & G \cdot {S}_{7} \\ H \cdot {S}_{9} & K \cdot {S}_{9} & N \cdot {S}_{9} \\ P \cdot {S}_{14} & Q \cdot {S}_{14} & R \cdot {S}_{14}\end{matrix} ) \cdot ( \begin{matrix}E1 \\ E2 \\ E3\end{matrix} ) = {M}^{′} \cdot \overline{E}\end{matrix} \qquad ( 9 )$$

If for example S₁₄=0, the equations become exactly solvable. However, even if none of the sensitivities is zero, the highest sensitivities will get more weight in the final solution, resulting in an optimised state of the system which is optimal for the particular application.

The second method for combining the two models is to optimise the system to one or more lithographic performance indicators. In one possible example the system is optimised for the performance indicator X-distortion (dx) in which case the IQEA model equation for this indicator can be written in the following manner:

$$\begin{matrix}dx ( X ) = {\sum }_{i} {Z}_{i} ( X ) \cdot {S}_{i} \\ = {\sum }_{i} ( {Z}_{i\_ 0} + {Z}_{i\_ 1} \cdot X + {Z}_{i\_res} ( X ) ) \cdot {S}_{i} \\ = {\sum }_{i} {Z}_{i\_ 1} \cdot {S}_{i} \cdot X + {\sum }_{i} ( {Z}_{i\_ 0} + {Z}_{i\_res} ( X ) ) \cdot {S}_{i} \\ = ( {Z}_{2 \_ 1} \cdot {S}_{2} + {Z}_{7 \_ 1} \cdot {S}_{7} + {Z}_{14 \_ 1} \cdot {S}_{14} ) \cdot X + {\sum }_{r} {Z}_{r\_ 1} \cdot \\ {S}_{r} \cdot X + {\sum }_{i} ( {Z}_{i\_ 0} + {Z}_{i\_res} ( X ) ) \cdot {S}_{i} \\ = ( {Z}_{2 \_ 1} \cdot {S}_{2} + {Z}_{7 \_ 1} \cdot {S}_{7} + {Z}_{14 \_ 1} \cdot {S}_{14} ) \cdot X + residuals\end{matrix} \qquad ( 10 )$$

where i=2, 7, 10, 14, 19, 23, 26, 30 and 34 and r=10, 19, 23, 26, 30 and 34

If the expressions for the lens adjustments are used for the three linear aberration terms (Z₂_{_{—}}₁, Z₇_{_{—}}₁, Z₁₄_{_{—}}₁) in this equation, it becomes:

$$\begin{matrix}dx ( X ) = ( {Z}_{2 \_ 1} \cdot {S}_{2} + {Z}_{7 \_ 1} \cdot {S}_{7} + {Z}_{14 \_ 1} \cdot {S}_{14} ) \cdot X + residuals \\ = ( A \cdot E1 + B \cdot E2 + C \cdot E3 ) \cdot {S}_{2} + \\ ( D \cdot E1 + F \cdot E2 + G \cdot E3 ) \cdot \\ {S}_{7} + ( P \cdot E1 + Q \cdot E2 + R \cdot E3 ) \cdot {S}_{14} + residuals\end{matrix} \qquad ( 11 )$$

This equation constitutes the integrated lens model equation which needs to be solved. In this solution the lens element positions (E1, E2 and E3) need to be found for which dx(X) becomes minimal (which will be very simple since there are three variables (lens elements) and only one equation). In reality there will be more lithographic errors that have to be optimised at the same time, making the solution more complex. For instance, if there is a requirement to optimise the defocus (dF), the second equation to be solved becomes:

$$\begin{matrix}dF ( X ) = {Z}_{9 \_ 0} \cdot {S}_{9} + residuals \\ = ( H * E1 + K * E2 + N * E3 ) \cdot {S}_{9} + residuals\end{matrix} \qquad ( 12 )$$

In this case both dx and dF need to become minimized by adjusting the lens elements.

In cases where there are an excess number of degrees of freedom, it is sensible to use this to make individual adjustable aberrations as small as possible, in order to make the general performance of the system as good as possible.

As shown in the data flow diagram of FIG. 6a, the lens model 12 provides an indication of the setting of the various lens adjustment elements that will give optimal lithographic performance for the particular lens arrangement used as will be described in more detail below, and can be used together with the IQEA model 11 to optimize the overlay and imaging performance of the lithographic apparatus during exposure of a lot of wafers. To this end the image parameter offsets (distortion errors, field curvature, etc.) from the IQEA model 11 are supplied to an optimizer 13 which determines the adjustment signals for which the remaining offsets in the image parameters will be minimized according to the user-defined lithographic specification (which will include, for example, the relative weighting to be allotted to the errors and will determine to what extent the maximum allowed value for the overlay error (dX) over the slit, for example, will be counted in the merit function indicating optimal image quality as compared with the maximum allowed value for the focus error (dF) over the slit). The parameters of the lens model are calibrated off-line.

During an optimization phase the adjustment signals are supplied by the optimizer 13 to the lens model 12 which determines the aberrations that would be induced in the lens if such adjustment signals were supplied to the lens. These induced aberrations are supplied to an adder 14 along with any measured aberration values; such that only the remaining aberrations are fed back to the IQEA model 11. The measured aberration values are supplied as a result of the previously described measurements at the start of the lot. Following such optimization of the image parameters, the resultant adjustment signals are supplied to the lens 15 or other adjustable element to effect the necessary compensating adjustments prior to exposure of the wafers.

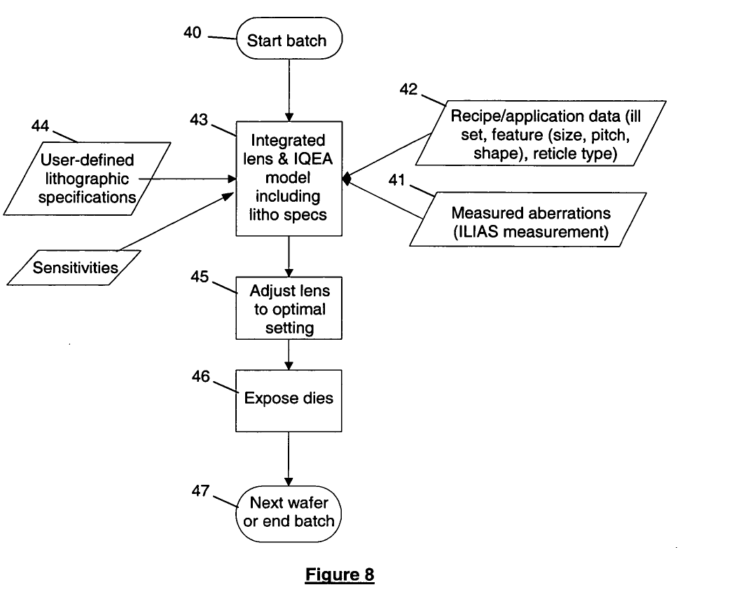

The computer arrangement serves to manipulate data using the combination 16 of a lens model and a linearized IQEA model, as shown in the data flow diagram of FIG. 7, to enable optimization of the adjustment signals in accordance with the user-defined lithographic specification to be implemented in one run (rather than separate runs having to be carried out for each of the image parameters to be optimized). The linearized IQEA model is derived from the IQEA model 11 by calculating the sensitivities of the model to the different types of aberrations, in a separate calculation step, as described in more detail above with reference to the two possible methods for combining the lens model and the linearized IQEA model. The combination 16 of the lens model and the linearized IQEA model receives the measured aberration values supplied as a result of the previously described measurements at the start of the lot, as well as the user-defined lithographic specification referred to above. The optimized adjustment signals are supplied by the combination 16 to the actuating device 15 of the projection system or other adjustable element to effect the necessary compensating adjustments.

The IQEA model 11 receives data indicative of the particular application (product pattern, illumination mode, mask type, etc), and provides output signals indicative of the sensitivities. These output signals effect the required adjustments to compensate for the aberrations of most relevance to the particular application, such adjustments being effected by way of adjustment signals supplied to one or more lenses of the projection system, and/or other adjustable parts of the apparatus, such as the substrate table, depending on the aberrations to be compensated for to optimize the overlay and imaging performance of the lithographic projection apparatus. Such image parameter offset output signals may serve to adjust for distortions in the XY-plane, deviations in the Z-plane normal to the XY-plane, or to adjust for offsets in more general imaging parameters, e.g. astigmatism. Other image parameter output signals may serve to adjust the CD or L1L2 for example.

The lens model provides an indication of the setting of the various lens adjustment elements that will give optimal lithographic performance for the particular lens arrangement used as will be described in more detail below, and can be used together with the IQEA model to optimize the overlay and imaging performance of the lithographic apparatus during exposure of wafers.

FIG. 8 is a flow chart illustrating the sequence of operations carried out in the computer arrangement in order to effect control and adjustment of the settings of the projection system such that the aberrations to which the particular application is most sensitive are compensated for as optimally as possible for the exposure of each of the dies of each wafer in a sequence of multiple die exposures of a lot of wafers. At the start of the exposure of the lot of wafers as indicated by the start lot box 40, a lot correction procedure is performed in which, prior to the sequence of exposures of the lot, the aberrations of the image are measured, for example, by the ILIAS or TIS technique to provide measured aberration data 41. The resulting aberration data 41 is supplied to the integrated lens/IQEA model that also receives the application data 42 (indicative of the features to be defined in the product with high accuracy, e.g. size, pitch and shape, the illumination mode, e.g. numerical aperture, sigma inner and outer, the dose of radiation to be applied during the exposure, the mask transmission, etc.) and the user-defined lithographic specification data 43 defining the user-defined end requirement of the application.

In a processing step 43 the integrated lens/IQEA model processes the measured aberration data 41, the application data 42 and the user-defined lithographic specification data 43, and determines from this data the modeled image parameter offsets, that are then used in a processing step 45 in the adjustment of the appropriate settings of the projection system, such as OVL values (X-Y adjustment), FOC values (Z adjustment), for optimizing the imaging performance. The dies on the wafer are then exposed with these settings in a processing step 46, and it is determined at 47 whether or not the procedure is to be repeated for the next wafer of the lot in dependence on whether or not the last wafer of the lot has been exposed. In the event that all the wafers of the lot have been exposed, a control signal transmitted to signal the end of the exposure of the lot of wafers.

The integrated lens/IQEA model is used in combination with the general aerial image and/or resist pattern calculation technique already discussed above, and the optimal lens state is found by calculating the effect on the aerial image and/or resist pattern for all lens settings of all the adjustable lens elements, in order to arrive at the optimal lens settings. The calculation of the aerial image and/or resist pattern is normally done by using commercial lithographic simulation packages, eg. Prolith, Solid C or Lithocruiser (the latter which is a product of ASML masktools). By inputting the characteristics of the projected image (size, shape, pitch), mask type, illuminator and projection lens, the simulation packages can calculate the resulting aerial image and/or, using a so-called resist model, the resulting resist pattern. Hereafter the general term “image” is used to mean either the aerial image and/or the resist pattern.

By fitting different algorithms to these images, it is possible to predict the performance of the lithographic system, the matched parameters being the lithographic performance parameters or lithographic errors. The process of determining the lithographic errors can best be illustrated by way of a few examples.

1. Best Focus, X-Displacement and CD (Aerial Image)

The aerial image of an 250 nm isolated space has a light intensity which varies as a function of the x-coordinate (horizontal position) and z-coordinate (vertical position)) shown. The z-coordinate with the highest intensity can be defined as best focus, and the cross-section of the aerial image at best focus can therefore be determined. Furthermore two intercepts can be determined at a particular threshold for the plot of the intensity against x-coordinate along this cross-section, and the average of these two intercepts can be defined as the X-displacement (position) of the image. The difference between these two intercepts can be defined as the CD of the image.

2. X-Displacement and CD (Resist Pattern)

Most commercial lithographic simulation packages also include resist models, and these resist models can be used to transfer the aerial image into the resist layer (on the virtual wafer). Various lithographic performance parameters of such a simulated resist pattern can be determined in this manner, such as the X/Y-displacement, the CD and the side wall angle.

TIS Reticle Alignment

The basic feature of a TIS reticle mark is an 250 nm isolated space the aerial image of which is detected (scanned) by way of a TIS sensor consisting of a 200 nm slit. To calculate [AJeu] the (aligned) position of a TIS reticle mark with a lithographic simulator the aerial image must be convoluted with the TIS sensor. Furthermore identical image fitting by the TIS alignment driver in the scanner must be effected to simulate the real performance of the TIS reticle alignment.

The measured and/or estimated total aberration is inputted into the IQEA model as one of the characteristics of the projection lens, together with the application data, and the output of the model or simulator supplies all relevant lithographic performance parameters defining a simulated distorted image. An optimiser optimises the difference between the performance parameters of the simulated distorted image and the performance parameters of the ideal image. This difference is evaluated with respect to the user defined specifications and determines whether the specification is met. If the specification is not met the parameter for adjusting the lens or other adjustable element must be adjusted to another (more optimal) setting to minimise this difference between the performance parameters of the simulated distorted image and the performance parameters of the ideal image. (It should be noted that, in this theoretical model, the optimiser and lens model work with a total aberration model rather than with an exponential expansion) The induced aberrations, as referred to above with reference to FIG. 6a, are again inputted into the model or lithographic simulator together with the measured-aberrations. This is continued until the lithographic specification is met and the optimal lens setting is reached.

In a more practical implementation both the lens model and the IQEA model and/or lithographic simulator use Zernike polynomial representation to describe the aberrations, so that the IQEA model is approximated by an expansion in Zernike terms (see equation 8 above). The output of the lithographic simulator takes the form of sensitivities that are to be used as coefficients in the approximated IQEA model. The sensitivities are determined by applying a certain aberration (Zernike) level and calculating the relevant lithographic performance parameter. The sensitivity of that lithographic performance parameter (for a particular aberration) is then calculated by dividing the lithographic performance parameter (e.g. displacement) by the applied aberration level. The following further steps are then implemented:

1. Determination of an ideal image. Since all aberrations are zero in the case of an ideal, non-distorted image, the performance indicator also has to be zero (Zi=0=>E(X)=0).

2. Determination of a simulated distorted image. The different (relevant) performance parameters are determined by using the sensitivities that have previously been calculated and all Zernike values generated by the lens model.

3. Determination of the deviation between the simulated distorted image and the ideal image. Although no separate calculation is necessary in this case because E(X)=0, it would be necessary to perform a further calculation if E(X)≠0 to determine the performance indicator difference between the distorted image and the ideal image.

4. Adjustment to minimise this deviation. The adjustment to minimise this deviation is carried out in the manner already described above for determining the lens element values that minimise the difference the ideal image and the predicted distorted image.

In a possible variant the lens model uses the individual aberrations but the IQEA model and/or lithographic simulator uses the total aberration (the sum of all the aberrations). The outputted lithographic performance parameters (for instance distortion) are then minimised by the lens model to provide the optimal lens setting.

Since the processing inherent in the various methods discussed above involves a large amount of combinations such processing will require a large number of calculations and will accordingly take a considerable amount of time. In principle new aberration measurements can be initiated at timed intervals (depending on known long-term aberration drift). However, if new aberration measurements are undertaken, the whole calculation/optimisation process must be redone for each new aberration set and this is therefore only practicable if there is adequate time available for the calculation/optimisation process at the available processing speed.

Reference has already been made above to the use of one or more transmission image sensors (TIS) mounted within a physical reference surface associated with the substrate table (WT) which may be used to determine the position of one or more marks on the mask (or reticle), as described in U.S. Pat. No. 4,540,277, in order to adjust the mask alignment. Advanced process control (APC) systems are commonly used to ensure good overlay. After exposure of a lot, the overlay is measured on a few wafers from the lot using a so-called overlay metrology tool, and the measured overlay data is sent to the APC system. The APC system then calculates overlay corrections, based on exposure and processing history, and these corrections are used to adjust the scanner to minimize the overlay error. This is also known as an overlay metrology feedback loop.

However, because of the distortion of the TIS marks and/or the overlay metrology targets and/or the wafer alignment marks due to the lens aberrations remaining after compensation for the specific product application, significant X-Y alignment errors may still exist, and, if adjustments are done to minimize the errors in the TIS marks and/or overlay metrology targets and/or the wafer alignment marks, these may be inappropriate to optimise the imaging performance during exposure of the product (or conversely to provide accurate alignment in the event that adjustments are done to minimize the product exposure errors).

Accordingly the IQEA model may be adapted to determine the appropriate corrections and permitted distortions for the different features (that is the product features, the TIS mask marks, the overlay metrology targets and the wafer alignment marks). Furthermore, since the different features are used at different points in the total lithographic control loop, it is important that the required error correction data is supplied to the right location.

In such an arrangement the IQEA model is disposed in a loop with a simulator to calculate the sensitivities of the different features. These sensitivities are input into the combined linearised-IQEA-model/lens model that calculates the optimal lens settings for the product features. These lens settings are then sent to a lens driver for making the necessary lens adjustments. Furthermore, TIS mask (or reticle) mark offsets calculated by this model are sent to a metrology driver that is able to correct for these offsets so that the right mask alignment parameters will be calculated in an unbiased way. The TIS mark offsets are used to correct the measured TIS positions prior to exposure of the wafers in order to ensure that the positions of the product features are correctly represented. The offsets of the exposed overlay metrology targets and the non-zero wafer alignment marks provided by the model, which data needs to be used at a different time and location, are sent to the APC system. The overlay metrology offsets are measured with respect to a previous layer and the distortion of the targets exposed in the previous layer should be taken into account, so that the data for the previous layer stored in the APC system is used, together with the data for the current layer, to calculate the total overlay offsets. The overlay metrology offsets are used to calculate the offset of the overlay metrology feedback and are accordingly supplied to the system that is going to expose the same layer in a feed forward arrangement. The wafer alignment mark offsets are supplied to the system that is going to expose the next layer in a feed forward arrangement.

A typical sequence of calculation in this case for determining the X-Y positions of the product and the positions of the TIS, overlay metrology and alignment features for each exposed die is as follows:

1. Just before exposure calculate the shifts in the X-Y positions of the TIS marks, the overlay metrology targets and the wafer alignment marks with respect to product position

2. Correct the measured TIS mark positions with the calculated offsets prior to exposure of the particular die on the wafer

3. Store the shifts for overlay metrology target positions in the APC-system, so that the APC feedback loop can be optimised for product overlay (the overlay on some wafers being measured). It should be noted that, when the overlay metrology tool measures an overlay, this will always be a difference in the shifts for the two layers, and the shifts for both layers need to be taken account of in determination of the metrology overlay target. For example, in the case of a box-in-box-structure, it will be necessary to take into account a shift for the inner-box (this shift having been determined when exposing this inner-box, because it was exposed with image adjustments optimised for the product) and a different shift for the outer box (this shift also having been determined already) in order to get the best possible estimate of the true overlay.

4. When exposing the next layer on each wafer, correct the measured wafer alignment mark positions with the calculated offsets before the exposure.

1. A method for modifying an image of a pattern during an imaging process, the pattern being arranged on a mask for imaging by a projection system on a surface, the image being an image formed from the pattern by a portion of the projection system, an imaging quality of said portion of the projection system being described by selected imaging quality parameters, and the projection system being adapted to adjust the image by image adjustment parameters, comprising:
(a) determining an ideal image of the pattern;
(b) determining a simulated distorted image of the pattern based on said selected imaging quality parameters;
(c) determining a deviation between the simulated distorted image and the ideal image; and
(d) adapting said image adjustment parameters during said imaging process to minimize the deviation between the simulated distorted image and the ideal image on the basis of said selected imaging quality parameters.

2. A method according to claim 1, wherein the portion of the projection system comprises one or more optical elements of the projection system.

3. A method according to claim 1, wherein said imaging quality parameters comprise low-order lens aberrations which relate to first distortion effects of the image which are independent of pupil plane filling in the projection system during the imaging process, and/or said imaging quality parameters comprise high-order lens aberrations which relate to second distortion effects of the image which depend on pupil plane filling in the projection system during the imaging process.

4. A method according to claim 1, wherein said adaptation of said image adjustment parameters comprises determination of image correction data for distortion coefficients by calculating settings for respective adjusting elements to obtain an image with minimal distortion, and using said image correction data as said image adjustment parameters for adjusting said adjusting elements.

5. A method according to claim 1, wherein said adaptation of said image adjustment parameters comprises determination of image correction data for distortion coefficients by:
(i) estimating, for each aberration type as defined by a respective Zernike coefficient, the sensitivity of an image feature to distortion with respect to the respective Zernike coefficient;
(ii) determining a first combination of the sensitivities for the aberration types in a first direction in the image; and
(iii) determining a second combination of the sensitivities for the aberration types in a second direction in the image, the second direction being substantially perpendicular to the first direction; and
(iv) using said image correction data as said image adjustment parameters for adjusting said projection system.

6. A method according to claim 1, wherein said image correction data is determined during said imaging process in a step-and-repeat mode.

7. A method according to claim 1, wherein said image correction data is determined on the basis of a slit coordinate during said imaging process in a step-and-scan mode.

8. A method according to claim 1, wherein said adaptation of said image adjustment parameters is optimised on the basis of data indicative of pupil plane filling of the projection system.

9. A method according to claim 1, wherein said adaptation of said image adjustment parameters is optimized on the basis of data indicative of the user-defined lithographic specification.

10. A method according to claim 1, wherein said adaptation of said image adjustment parameters is optimized by providing for the aberrations to which the particular application is sensitive to be compensated for according to an optimum requirement.

11. A method according to claim 1, wherein said adaptation of said image adjustment parameters includes measuring the aberrations of said portion of the projection system and calculating settings for respective optical elements within said projection system based on image correction data derived from the measured aberration values.

12. A method according to claim 1, wherein a further processing is provided in which the effect of a shift in associated overlay metrology and/or wafer alignment marks as a result of the imaging adjustment is compensated for on the basis of an optimisation procedure.

13. Apparatus for modifying an image of a pattern during an imaging process, comprising:
an mask table constructed and arranged to support a mask;
a projection system; and
a control system adapted to control and adjust machine parameters during execution of an imaging process and comprising a processor, a memory for storing instructions and data, and input/output circuitry for handling signals transmitted to and received from actuators and sensors in said projection system, said processor being connected to said memory for processing said instructions and data and to said input/output device for controlling said signals,
wherein the pattern is arranged on said mask for imaging by the projection system on a surface, the image being an image formed from the pattern by a portion of the projection system, an imaging quality of said portion of the projection system being described by selected imaging quality parameters, and said projection system being adapted to adjust the image by image adjustment parameters,
and wherein the control system is further adapted to perform a method comprising:
(a) determining an ideal image of the pattern;
(b) determining a simulated distorted image of the pattern based on said selected imaging quality parameters;
(c) determining a deviation between the simulated distorted image and the ideal image; and
(d) adapting said image adjustment parameters during said imaging process to minimize the deviation between the simulated distorted image and the ideal image on the basis of said selected imaging quality parameters.

14. Apparatus according to claim 13, wherein said control system is adapted to optimize said adaptation of said image adjustment parameters on the basis of data indicative of pupil plane filling of the projection system.

15. Apparatus according to claim 13, wherein said control system is arranged to optimize said adaptation of said image adjustment parameters on the basis of data indicative of the user-defined lithographic specification.

16. Apparatus according to claim 13, wherein said control system is arranged to optimize said adaptation of said image adjustment parameters by providing for the aberrations to which the particular application is most sensitive to be compensated for according to an optimum requirement.

17. A method according to claim 13, wherein said control system is arranged to optimize said adaptation of said image adjustment parameters by measuring the aberrations of said portion of the projection system and calculating settings for respective optical elements within said projection system based on image correction data derived from the measured aberration values.

18. Apparatus according to claim 13, wherein said control system is arranged to carry out further processing in which the effect of a shift in associated overlay metrology and/or wafer alignment marks as a result of the imaging adjustment is compensated for on the basis of an optimization procedure.

19. A machine readable memory comprising machine executable instructions for use in an apparatus comprising a mask, a projection system, and a control system adapted to control and adjust machine parameters during execution of an imaging process and comprising a processor, a memory for storing instructions and data, and an input/output device for handling signals transmitted to and received from actuators and sensors in said projection system, said processor being connected to said memory for processing said instructions and data and to said input/output device for controlling said signals,
wherein the pattern is arranged on said mask for imaging by the projection system onto a surface, the image being an image formed from the pattern by a portion of the projection system, an imaging quality of said portion of the projection system being described by selected imaging quality parameters, and said projection system being adapted to adjust the image by image adjustment parameters,
the machine executable instructions comprising instructions for performing a method comprising:
(a) determining an ideal image of the pattern;
(b) determining a simulated distorted image of the pattern based on said selected imaging quality parameters;
(c) determining a deviation between the simulated distorted image and the ideal image; and
(d) adapting said image adjustment parameters during said imaging process to minimize the deviation between the simulated distorted image and the ideal image on the basis of said selected imaging quality parameters.

20. Lithographic projection apparatus comprising:
an illumination system for conditioning a beam of radiation;
a support structure for supporting a patterning device, the patterning device serving to pattern the beam according to a pattern;
a substrate table for holding a substrate; and
a projection system for projecting the patterned beam onto a target portion of the substrate, the pattern being arranged on said patterning device for imaging by a projection system on a surface, the image being an image formed from the pattern by at least a portion of the projection system, an imaging quality of said portion of the projection system being described by selected imaging quality parameters, and said projection system being adapted to adjust the image by image adjustment parameters; and
a control system adapted to perform a method comprising:
(a) determining an ideal image of the pattern;
(b) determining a simulated distorted image of the pattern based on said selected imaging quality parameters;
(c) determining a deviation between the simulated distorted image and the ideal image; and
(d) adapting said image adjustment parameters during said imaging process to minimize the deviation between the simulated distorted image and the ideal image on the basis of said selected imaging quality parameters.
